(19) United States
(12) Patent Application Publication
(10) Pub. No.: US 2018/0134540 A1
(43) Pub. Date: May 17, 2018

(54) Portable water dispenser having a pressure booster faucet for pushing water through an ionizing device

(71) Applicant: Vicente P. Garcia, Montreal (CA)

(72) Inventor: Vicente P. Garcia, Montreal (CA)

(21) Appl. No.: 15/810,212

(22) Filed: Nov. 13, 2017

(30) Foreign Application Priority Data
Nov. 17, 2016 (GB) 1619493.8

(51) Int. Cl. B67D 1/12; B67D 1/00

(52) U.S. Cl. CPC B67D 1/12; C02F 2001/4619; B67D 2210/00118; B67D 1/0004

(57) ABSTRACT

A portable water dispenser includes a housing and a bottle receptacle on a top portion of the housing to receive a water bottle. An ionizing device and a pressure booster to increase the pressure of the water so the water can pass through the ionizing device and supply ionized alkaline water out a faucet. The supply of ionized water from a portable water dispenser is an improvement over non-portable applications. At least one outlet hose is used to store the ionized acidic water produced by the ionizing device.

### CROSS-REFERENCE TO RELATED APPLICATIONS

The present application claims priority to United Kingdom Patent Application serial number GB1619493.8, filed on Nov. 17, 2016 entitled “PORTABLE WATER DISPENSER HAVING A PRESSURE BOOSTER FAUCET FOR PUSHING WATER THROUGH AN IONIZING DEVICE”, the disclosure of which is hereby incorporated in its entirety at least by reference.

### BACKGROUND OF THE INVENTION

### 1. Field of the Invention

The present invention generally relates to water cooler units but more particularly to a portable water dispenser having a pressure booster faucet for pushing water through an ionizing device.

### 2. Description of Related Art

Alkaline water is less acidic than tap water, having a pH greater than 7. It is well known that there are many benefits to drinking alkaline water, including but not limited to being an antioxidant, balancing the pH levels of the body, and increased hydration. A water ionizer is an electrolyzer configured to raise the pH of drinking water by using electrolysis. Further there are claims that ionized water has other health benefits including helping fight disease. Currently, there is a water ionizing apparatus having an adapter that connects to a kitchen faucet so that you can redirect tap water to an ionizer or various types of water treatment device. However, there does not seem to be a device that can provide ionized water in places where there is no running water available. Consequently, there is a need for a portable water dispenser configured to provide alkaline water.

### BRIEF SUMMARY OF THE INVENTION

In one embodiment a portable water dispenser is provided, comprising: a housing; a bottle receptacle configured to receive a water bottle configured to hold water, wherein the bottle receptacle is positioned on a top portion of the housing; a faucet positioned on the top portion of the housing; an ionizing device; and a pressure booster configured to increase the pressure of the water such that the water can pass through the ionizing device and supply ionized alkaline water out the faucet, wherein the water bottle, the faucet, the ionizing device, and the pressure booster are in fluid connectivity along a first conduit.

In one embodiment, at least one outlet hose configured to supply ionized acidic water is provided. In one embodiment, the ionized acidic water is stored in at least one water container. In another embodiment, a water heater and a refrigerating system are provided to heat and cool the water respectively. In yet another embodiment, a hot spigot and a cold spigot are provided to provide the heated and cooled water respectively. In one embodiment, a second conduit in fluid connectivity the water bottle, the hot spigot, and the cold spigot is provided, wherein the second conduit is configured to provide non-ionized water out the hot and cold spigot.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIGS. 1A-B are perspective views of portable water dispenser having a pressure booster faucet for pushing water through an ionizing device according to an embodiment of the present invention.

FIGS. 2A-B are front and side perspective views of the portable water dispenser with a bottle installed according to an embodiment of the present invention.

FIGS. 3A-B are top and rear perspective views of the portable water dispenser with the bottle removed according to an embodiment of the present invention.

FIG. 4 is a rear perspective view of the portable water dispenser with a bottle showing water containers being filled according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a portable water dispenser having a pressure booster faucet for pushing water through an ionizing device.

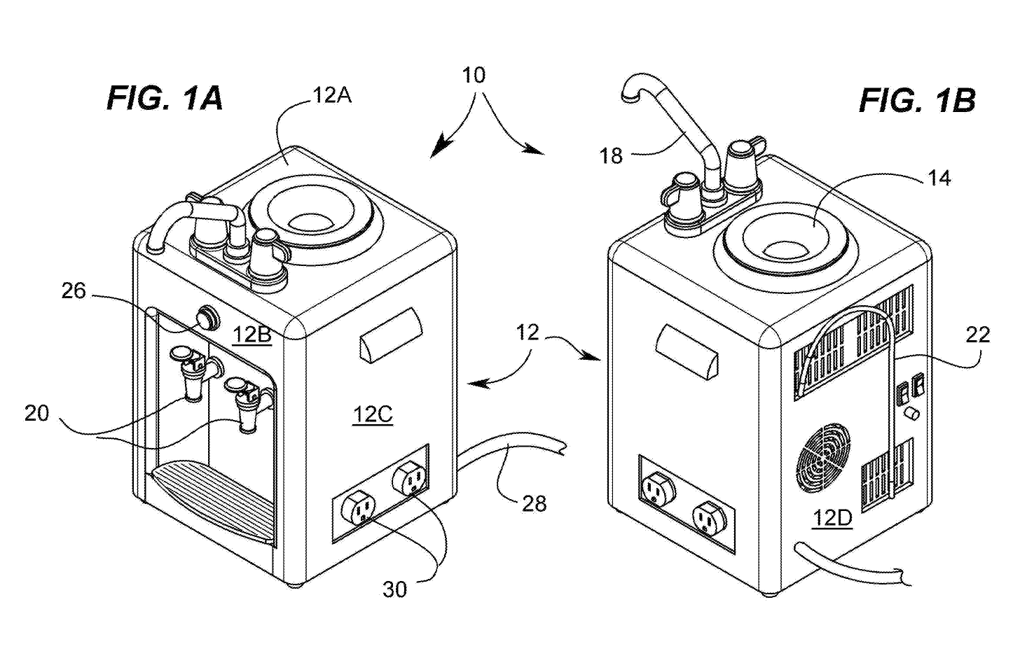

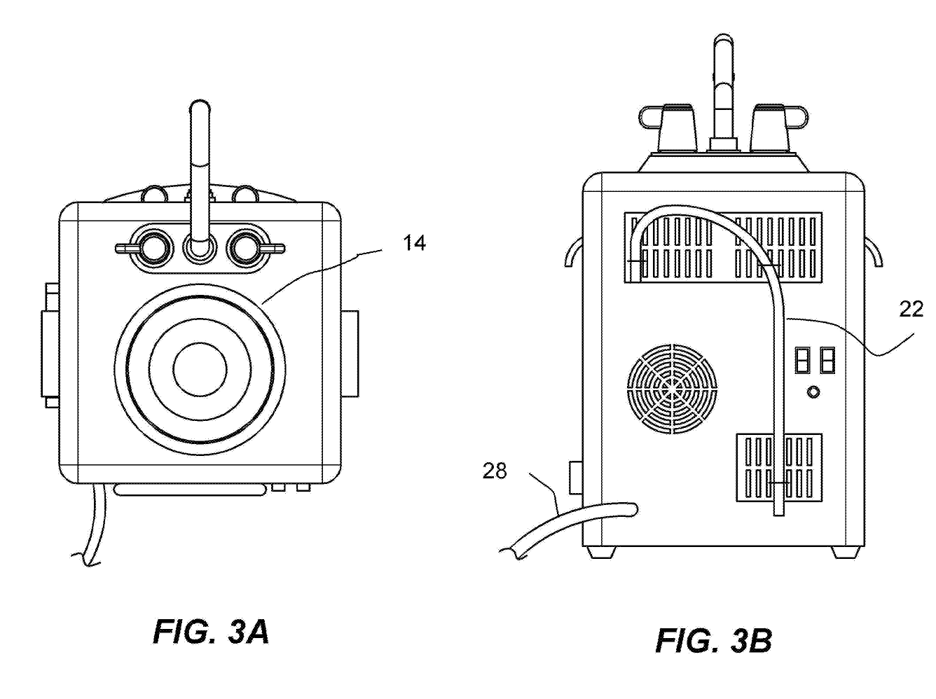

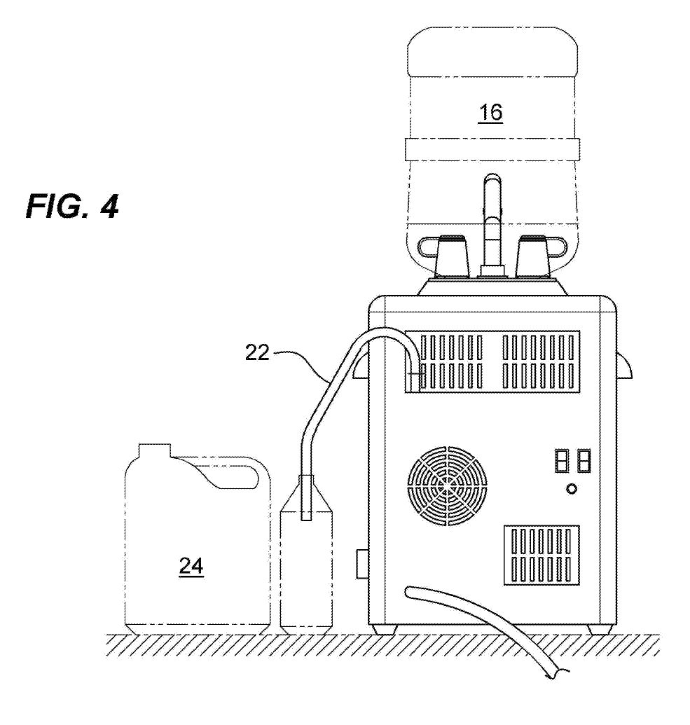

Referring now to any of the accompanying FIGS. 1-4, a portable water dispenser 10 is illustrated. The portable water dispenser includes a housing 12 having a top portion 12A, a front portion 12B, a side portion 12C, a back portion 12D, and a bottom portion 12E. In one embodiment, the housing is substantially rectangular as illustrated. In alternative embodiments, the housing is cylindrical. A bottle receptacle 14 is positioned on the top portion of the housing, wherein the bottle receptacle is configured to receive a water bottle 16. The water bottle is preferably a standard 5 gallon water bottle designed to hold water as well known in the art. In one embodiment, the water is filtered water.

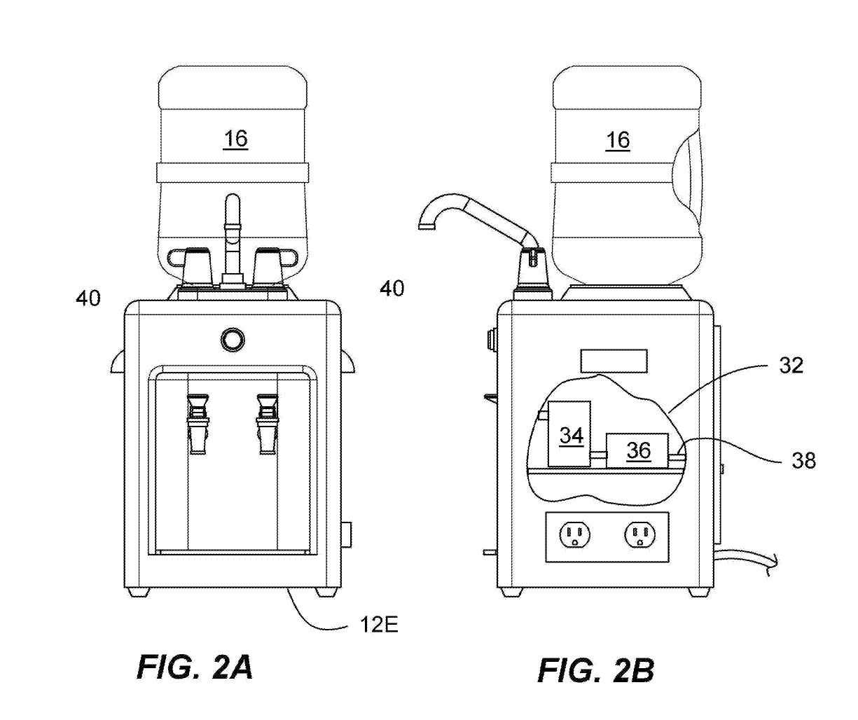

In one embodiment, a faucet 18 is positioned on the top portion of the housing. The faucet is a standard kitchen style faucet. An ionizing device 34 and a pressure booster 36 are provided in the housing along a first conduit 38 (best seen in cutaway 32; FIG. 2B). The first conduit is in fluid connectivity with the water bottle and faucet as well.

In one embodiment, a front panel 44 is included on the front portion of the housing, wherein the front panel includes a hot and a cold spigot 20. A water heater and a refrigerating system (not shown) are included to heat and cool the water, which is provided to a consumer via the hot and cold spigots as well known in the art. In one embodiment, a second conduit is provided, wherein the second conduit is in fluid connectivity the water bottle, the hot spigot, and the cold spigot. It is a particular advantage of the present invention to provide two conduits such that one conduit can provide non-ozonized water. The operation of the water dispenser will be discussing in further detail below.

A power cord 28 is included to provide alternating current to the electrical components in the hosing as well known in the art. In one embodiment, power outlets 30 positioned on the side portion of the housing provide the convenience of powering smaller electronic devices when the water dispenser is in use.

In operation, a consumer has the option for ionized alkaline and non-ionized water, i.e. water straight from the water bottle. When ionized alkaline water is desired, the consumer presses an on/off switch 26 activating the pressure booster. Next, when the faucet is turned on the water traveling along the first conduit goes from the water bottle, through the pressure booster, which increases the water pressure so that the water can travel through the ionizing device. The ionizing device may be any ionizing device known in the art, however generally the ionizing device separates the water into ionized alkaline water and ionized acidic water. The ionized alkaline water exits through the faucet and the ionized acidic water exits through at least one outlet hose 22. Preferably, the ionized acidic water can be stored in at least one container 24. The stored ionized acidic water is useful for a variety of functions and benefits, including but not limited to being a natural antiseptic, a sterilization agent, and having anti-bacterial properties. It can also be used to water plants and vegetables as well as an improving agent for a person's mouth, hair, and skin. So not only does the present invention provide the benefits of ionized alkaline water as previously discussed, useful ionized acidic water is provided as well.

In one embodiment, as previously mentioned the second conduit is in fluid connectivity with the water bottle, the hot spigot, and the cold spigot. Thus, the consumer can use the portable water dispenser without turning on the pressure booster if standard water straight from the water bottle is desired. This water can be provided hot or cold, and in alternative embodiments, at a natural temperature, i.e. room temperature corresponding to the temperature of the water stored in the water bottle. It should be noted, that the ionized alkaline water provided to the faucet can also be temperature controlled.

Further, the portability of the water dispenser is a particular advantage of the present invention. The housing is provided with handles 40 configured to aid in the moving of the dispenser. In one embodiment, the handles are provided on each side portion of the housing. Legs 42 are positioned on the bottom portion of the housing providing a sturdy base for the water dispenser. In one embodiment, the legs include wheels (not illustrated) to aid in transport. The portability is critical as standard ionizing devices are used in home kitchens where a water line is needed from a water source, such as a tap. The present invention provides a solution, utilizing a water bottle enabling ionized alkaline water to be provided in places where a water line is not available, such as campsite, a backyard, or a deck. It is another advantage, that the present invention can be used by salespeople wanting to show water ionizers in public demonstrations at shopping malls, private homes, and various public events.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A portable water dispenser comprising:
a housing;
a bottle receptacle configured to receive a water bottle configured to hold water, wherein the bottle receptacle is positioned on a top portion of the housing;
a faucet positioned on the top portion of the housing;
an ionizing device; and
a pressure booster configured to increase the pressure of the water such that the water can pass through the ionizing device and supply ionized alkaline water out the faucet, wherein the water bottle, the faucet, the ionizing device, and the pressure booster are in fluid connectivity along a first conduit.

2. The portable water dispenser of claim 1, further comprising at least one outlet hose configured to supply ionized acidic water.

3. The portable water dispenser of claim 2, wherein the ionized acidic water is stored in at least one water container.

4. The portable water dispenser of claim 1, further comprising a water heater and a refrigerating system to heat and cool the water respectively.

5. The portable water dispenser of claim 4, further a hot spigot and a cold spigot to provide the heated and cooled water respectively.

6. The portable water dispenser of claim 5, further comprising a second conduit in fluid connectivity the water bottle, the hot spigot, and the cold spigot, wherein the second conduit is configured to provide non-ionized water out the hot and cold spigot.
